(19) United States
(12) Patent Application Publication
(10) Pub. No.: US 2009/0247141 A1
(43) Pub. Date: Oct. 1, 2009

(54) MOVING OF A NODE

(76) Inventor: Bent Halvard Vale, Grimstad (NO)

Correspondence Address: ERICSSON INC., 6300 LEGACY DRIVE, M/S EVR 1-C-11, PLANO, TX, 75024, US

(21) Appl. No.: 12/278,463

(22) PCT Filed: Feb. 10, 2006
(86) PCT No.: PCT/NO2006/000055

§ 371 Date: Aug. 6, 2008

(51) Int. Cl. H04M 3/00

(52) U.S. Cl. 455/418

(57) ABSTRACT

A system and a method for moving a node within a real time communications network, where said node is at least connected to a first controller node and the node is disconnected and moved from the first controller node to a second controller node, where the system comprises a macro adapted to handle moving of the node and the method uses the same macro. According to the present invention the macro will delete data in the a first controller node, thereafter generate new data adapted to a second controller node by reusing data associated with said node, and where the node is assigned a identity associated with the second controller node.

### TECHNICAL FIELD

The present invention is related to moving a node within a communication system and more particularly to a system and a method for moving a node within a real time communications network, where said node is at least connected to a first controller node and the node is disconnected and moved from the first controller node to a second controller node.

### BACKGROUND ART

Moving of a Node B, or a node with similar nature and capabilities, from one radio network controller (RNC) to another is necessary in a telecommunication network, when cell architecture is reorganized due for example to lack of capacity or reorganising of location area to make handovers more efficient and not so resource demanding.

There are a number of situations that initialises the need for moving a Node B, RBS or other similar nodes, the ever increasing traffic load demands a continuously update of capacity, hence new base stations, and controllers will regularly be added to networks, Changes in infrastructure in the society can originate changes in network capacity or needs for geographical/topographical reorganisation of existing network. These changes in infrastructure can be building of new motorways, shopping centres, residential areas, industrial estate, i.e. construction of new areas where there will be an increased need for telecommunication traffic.

Moving of a node from one location to another is not necessarily meant literally, the moving is rather the act of disconnecting a node from one controller and connecting it to another controller, which is the same as relocating the control of the node from one controller to another controller. This relocation does not involve any physical movement of hardware equipment as such, but it implicates that software applications/routines/programs are deleted at the first place and implemented at the next place. Such an implementation includes establishing new addresses, new access points, new name conventions, new address mappings etc. for the moved node.

If an operator purchases a new RNC or a new similar controller node so as to unload a congested/overloaded network he will not necessarily move the B nodes or similar radio nodes in the literal sense of the word, however he will in an administratively manner move existing radio nodes such as B-nodes from existing controller nodes such as RNC's to the newly purchased node. This relocation is realised using software and it needs a thorough knowledge, manpower resources and, it generates down time, hence such resource allocations are postponed as long as possible.

In your office this relocation is analogue to a situation where you for example experiences poor signal quality from a LAN transmitter, or you experience congestion in the data traffic, instead of moving your office or your personal computer you are more likely to search for resources that have better capacity, thus changing from one LAN access point to a new or from one data node to a new. Thus a situation where you are reaching the limit of a node or a server will force you to find new available resources. When the capacity limit of a server is reached a lot of unnecessary signalling will be generated. A relocation of network resources like this is much the same as moving a Node B from one controller to another controller, where the Node B in this example is analogue to your personal computer. However it is much more complex to move a Node B.

In GB-2414361 it is disclosed a method for relocation of mobile terminals from one base station controller to another base station controller in universal mobile telecommunication system (UMTS) network. Applicable in a time division duplex (TDD) third generation partnership project (3GPP) radio communication system. However there is not discloses any solution to the problems involved in moving nodes such as Node B's.

From RU-0126891 it is known a method and device characterized in that one or more active duplex signal repeaters are connected to temporarily underloaded base stations. Signal repeaters are mounted in service area of one or more base stations that are situated at so-called hot spots, such as exhibitions, conferences, fairs, and the like. This document does not disclose an effective way of moving a node such as Node B; however it pinpoints the problem of distribution of network resources.

And in the Korean application KR-0046531 it is disclosed a method for effectively relocating a serving radio network subsystem in an asynchronous CDMA mobile communication system so as to save resources of a mobile communication system by guaranteeing optimization of a path in providing a service to a UE (User Equipment). This solution merely indicates a method for effective handover of UE.

### DISCLOSURE OF THE INVENTION

### Technical Problem

Today moving of a node, such as Node B involves the deletion of the Node B at one controller (deleting in a software manner) such as a RNC and to recreate it in another RNC using a hierarchical top level system for control, planning and supervision of networks such as an OSS-RC and/or Script. This is a very manually and time consuming operation. In addition, staff doing installation must undertake a comprehensive course to be able to perform the task, i.e. not a plug and play situation.

As a consequence of the complex routines involved when moving a Node B, RBS or similar there are not many people employed at telecommunication operators that are able to do this work, thus telecommunication operators have to hire staff to do the work.

The complexities and the resource demanding work involved when moving radio nodes as indicated above may result in poor utilization of available network resources, an operator is reluctant to start the process of moving a radio node, thus he will postpone it. In addition to the disadvantage of complexity involved when moving nodes one can add down time to it. For an operator down time should be kept at an absolute minimum, downtime leads to handling of extra traffic at equipment that operates.

Routines of such complexities as those involved in the movement of radio nodes are also prone to faults, hence it can lead to unnecessary down time and resource demanding trouble shooting.

The complexity, the cost, and the down time associated with “node-moving” implicates poor utilization of available network resources; it increases the gap between good network planning and enforcement of the result of such planning.

Today moving of a node such as a radio base node (Node B) comprises the steps of starting a SW program for deleting connection data for the old node (Node B) in an “old” controller node such as a RNC. Give input data for the connection in a “new” controller node RNC (Atmport, VPI/VCI, RNC Module, AESA) these data's will then be put in a macro or script, which is to be run in the new RNC. FIG. 2 shows a block diagram for the operations and type of input, further following below are instructions in text disclosing an example of today's method of moving a Node B according to these instructions. This example is only included to serve as an example indicating the complexity of moving a radio base node such as a Node B; the example is typical for moving a Node B from one Ericsson RNC to a new RNC. Other vendors use correlative routines for moving radio base stations from one controller node to a new controller node. It can easily be understood that such complex algorithms for moving a node can generate faults and it can lead to delayed relocation of nodes.

Deletion of the node that is to be moved via Ranos, (i.e. an operating system preceding the WRAN Explorer/WCDMA Ran Explorer) in the “old” controller node, in the following subsection denoted RNC. Delete the following:
Right click on the node that is to be moved such as RBS or Node B, in the following subsection denoted RBS and select “Adjacent cells”. Mark all neighbours, “delete”.
   Right click on RBS and select “Cells”. Mark all cells, “delete” and thereafter “Apply”.
   Select Configuration in the Tools menu up in Ranos and select “Area”. In the new frame which occur, select RbsGroup,
   Select RNC and SA's and press arrow such that the marked SA's will be moved over to the right window in the frame.
   Select the button SA in the picture below, mark “delete” and “Apply”.
   Right click on RBS and select “Configuration” and “Nbap Dedicated” (i.e. an application protocol for a Node B). Mark the line in the picture below and “delete” and thereafter “Apply”.
   Right click on RBS and select “Configuration” and “Nbap Common”. Mark the line in the picture below and “delete” and thereafter “Apply”.
   Right click on RBS and select “Configuration” and “Synchronization”. Mark the line in the picture below and “delete” and thereafter “Apply”.
   Right click on RBS and select “Configuration” and “Logical link”.
   Select the links one by one, right click “delete” and “apply”; remember to delete Q2630 Aal2 as the last item.
   Select Configuration in the Tools menu up in Ranos and select Transport network and TPC Wizard.
   Select RNC and press on the arrow to the left to move it over to the right side, then double click on RNC,
   Select RBS group and select correct RBS and then press the right arrow again. Then select “VP only” in the menu lines on the top of the frame
   Then press on “disconnect” button to the right, the “next” button in the next frame, remember to write down Atmport and VP before continue the deletion.
   Select “Apply”. Then select “ATM only” in the menu lines on the top of the frame, press “disconnect” button to the right and “Ok” button in the next frame.
   Open Cello/OE on the RNC and delete the VP on the ATMport which was written down in the previous point.

Now select the RBS in the RNC/RBS radio view in Ranos remember to write down data from “properties” (Transmission line identity, long name (signature) and description)),
Right click, select “Delete NE/RBS group” and then OK on each frame that pop up until reaching a status frame that states “RBS deleted”: i.e. your RBS”
   Then contact an ATM based transmission node and ask it/them to move over the RBS.
1. Install Script in “new” RNC.
2. Define RBS in new RNC.
   Remember to select MIM version: C.5.0.C.1.6 and remember not to fill in complete DNS name yet, further don't select dependent data. Select “Prepare” and write in AESA and port 1-2-1 and press “Add” and then OK.
3. Write in AtmPort with Configuration in tools menu in Ranos and select Transport network and TPC Wizard.
   Instead of “disconnect” select now “AtmPort only” and “connect”. Be aware, and select correct ATMPort, the correct ATMPort can be found in a spreadsheet with transmission configurations.
4. Now it is possible to “restart” the RBS. Change thereafter the DNS name on the RBS in Ranos to the correct name.
5. Change the Aal2 PathId on the RBS so it is like the one in the “new” RNC.
6. Change the Aal2RoutingCase (i.e. ATM address that is to be specified) on the RBS to the new RNC.
   a. Write in lub, the lub denoting a connection between a RNC and a RBS (Node B) Label apparent from a spreadsheet with transmission configurations in lub Link properties.
7. Write in Aal2RoutingCase for the new RBS in the RNC.
8. Unlock Sync, NBAPC, NBAPD and Cells.
9. Check in the RBS that the radio channels come up (Radioview->Cell->Carrier). 9 channels should be “enabled”.
10. Make new CV to the RBS.
11. Write in VPs and VCs in Ranos (Configuration->Transport network->Termination point connector->TPC Wizard).
   Click on the RNC and put it over to the right frame. Then double click on the RNC on the left side until the actual RBS is located and put also it over to the right side.
   Select Connection mode ATM+VP, click then connect and write in the ATM port, select correct transmission card e.g. ETM-4 card and be careful to select the RBS_{—}01_D port, and the correct VP (same as the VP point for the RBS on the RNC).
   Then select Aal only Connection mode and write in all the VC's with the apply button.
1. If the process was successful, it is possible to start again on a new RBS

### Technical Solution

The principle of the system and the corresponding method is to reuse data that are common in a old setup and a new setup, i.e. only change manually necessary data for the moving such as name/identity of new RNC, AtmPort and module for the Node B to be connected to, alternatively one may accept that the name/identity of the new RNC, etc. is auto generated by the system, thus using a system generated name convention. The latter method reduces the manual workload, at the expense of loosing control over the name setting. However it is according to the present invention perfectly acceptable to rename said name/identity at a later stage/time.

Furthermore, the necessary data and scripts can be exported, modified and then imported again in WCDMA RAN Explorer. By using this function together with a macro, the whole process can be made much simpler. A lot of the data is standardised and it is only needed to put in the specific data for the RBS like RBS name, RBS Identity, RNC name, RNC module, AtmPort, VPI/VCI and cell data, unless if an operator wants to use auto generated names. In the following the invention is described by an embodiment not utilizing the possibility for auto generating names/identities. Since the RBS name, identity and cell data in most cases will be the same, these data can be kept unchanged. On the RBS it is only necessary to change the Aal2 Routing Case towards the RNC and in that the particular data the ATM End Address for the RNC which the RBS is routing toward. Changing the labels for which RNC the RBS now belongs to can be automatic and the operator can change the data if he or she wants too. The ATMEnd address is unique to the Node-B, the Aal2 Routing Case assigns the address mapping of Node-B.

### ADVANTAGEOUS EFFECTS

The system and method according to the present invention will save time in moving a radio base station node such as a Node B from one controller node such as an RNC to another RNC. Further, the simplified method will reduce the possibility for erroneous implementations. Still further the reduced complexity will require less manpower and it will be easier to educate staff to do these kinds of jobs. Still further an operator will take advantage of the easy relocation algorithm by using own personnel to this job, resource allocation will be easier to handle by an operator, hence resulting in a better resource utilization.

All these advantages can be achieved by a system for moving a node within a real time communications network, where said node initially is at least connected to a first controller node and said node is disconnected and moved from the first controller node to a second controller node. And where the system comprises a macro adapted to handle moving of the node by executing at least the steps of; deleting data in the first controller node, generating new data adapted to the second controller node by reusing data associated with said node, and said node is assigned a identity associated with the second controller node.

Still further, the advantages according to the present invention is achieved by a method for moving a node within a real time communications network, where said node initially is at least connected to a first controller node and said node is disconnected and moved from the first controller node to a second controller node, where the method utilizes a macro that executes at least the following steps;
a) deleting data in the first controller node,
b) generating new data adapted to the second controller node by reusing data associated with said node, and
c) assigning a identity associated with the second controller node to said node.

Other advantageous effect by the present invention will become apparent by the appending dependent claims.

### BRIEF DESCRIPTION OF THE DRAWINGS

In the following is a brief description of the drawings disclosed.

FIG. 1 shows a block diagram discloses where in a network to carry out changes when moving a Node-B,

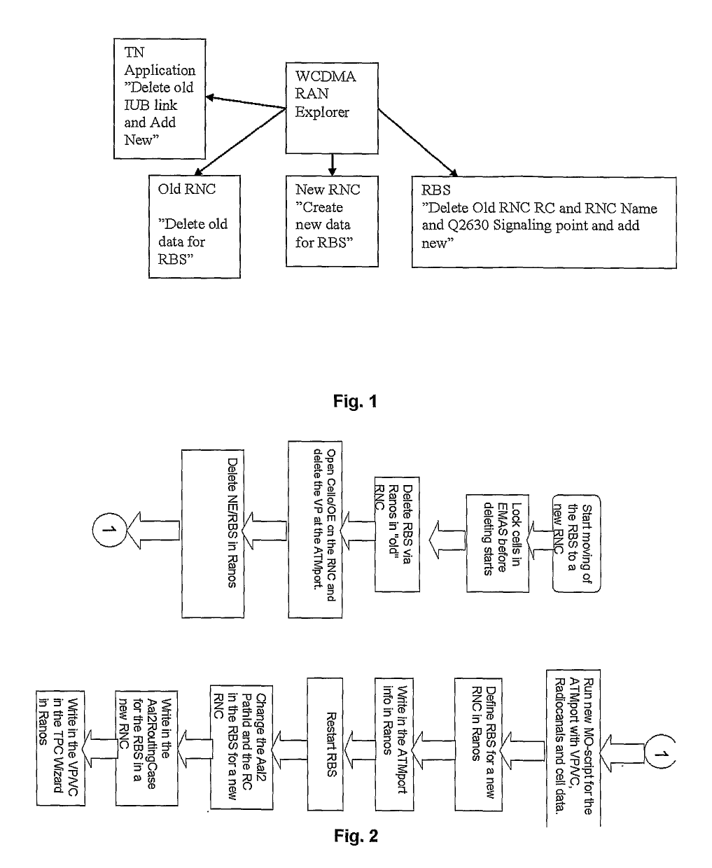

FIG. 2 shows a flow chart of a manual procedure for moving a Node-B,

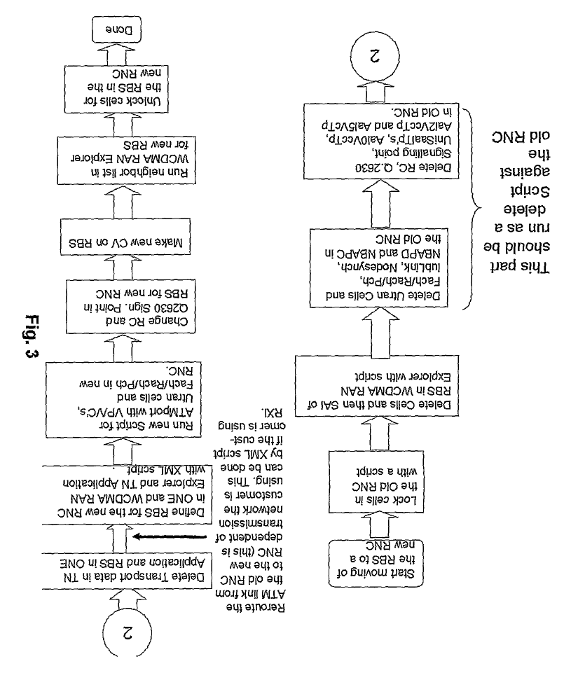

FIG. 3 shows a flow chart according to the present invention, where a Node-B is automatically or semi automatically moved from one RNC,

FIG. 4 shows a first part of a flow chart according to the present invention, where a radio base station of any kind is moved from one controller node to another controller node, and shows a second part of a flow chart according to the present invention, where a radio base station of any kind is moved from one controller node to another controller node.

### MODE(S) FOR CARRYING OUT THE INVENTION

In the following a detailed description of the present invention will be disclosed with reference to the accompanying drawings.

The drawings are included herewith so as to ease the understanding of the present invention and they are not intended to indicate the scope of protection as defined by the claims.

Wherever in the following where the wording Node-B is used it is to be understood that Node-B can be substituted with any node adapted to perform services traditionally associated with RBS's or other radio nodes having the same capabilities and further being administratively controlled by a Radio Network Controller or a similar node. Thus the use examples herein that make reference to UMTS are merely meant as illustrative examples.

Wherever in the following where the wording UMTS is used it is to be understood that UMTS can be substituted with any network that chares a similar node topology. The use of UMTS is intended to ease the readability of the specification by using a concrete example.

In the following are embodiments of equal value disclosed by way of example.

The principle of the method and system according to the invention is based on an idea of reusing data that can be reused and further only change necessary data for node relocation (example name/identity of new RNC, AtmPort and module for the Node B to be connected to). Hence data that are common for an old setup and a new setup can be reused, by storing data associated with the old setup.

The relocation is necessary when cell architecture is reorganized due to for example not enough capacity or changing location area to make handovers more efficient and not so resource demanding.

The method used today involves deletion of a Node B in one RNC and recreation of the same Node B in another RNC by using Operating System Support Software (Radio Configuration mode) and Scripts. This is a manually based, and time consuming operation, as indicated in the previous section disclosing the instructions for moving of RBS's.

The invention describes an automatic relocation method for Moving a Node B from one Radio Network Controller to another Radio Network Controller.

Furthermore, the necessary data and scripts can be exported, modified and then imported again in configuration software such as WCDMA RAN Explorer. By using this function together with a macro, the whole process can be made much more automatic. The new method reuses the data that is possible to reuse and only changes data necessary for moving (example name/identity of new RNC, AtmPort and module for the Node B to be connected to). A lot of the data is standardised and it is only needed to enter the specific data for the RBS like RBS name, RBS Identity, RNC name, RNC module, AtmPort, VPI/VCI and cell data. Since the RBS name, identity and cell data in most cases will be the same, it is even possible to keep that data unchanged. Further one may adopt automatic name generation that is wherever possible, the names and identities of RBS name, RBS Identity, RNC name, RNC module, AtmPort, VPI/VCI and cell data will be given by the script thus using a system generated name convention. The latter method reduces the manual workload, at the expense of loosing control over the name setting. However it is according to the present invention perfectly acceptable to rename said name/identity at a later stage/time.

On the RBS it is only necessary to change the ATM End Address and Aal2 Routing Case.

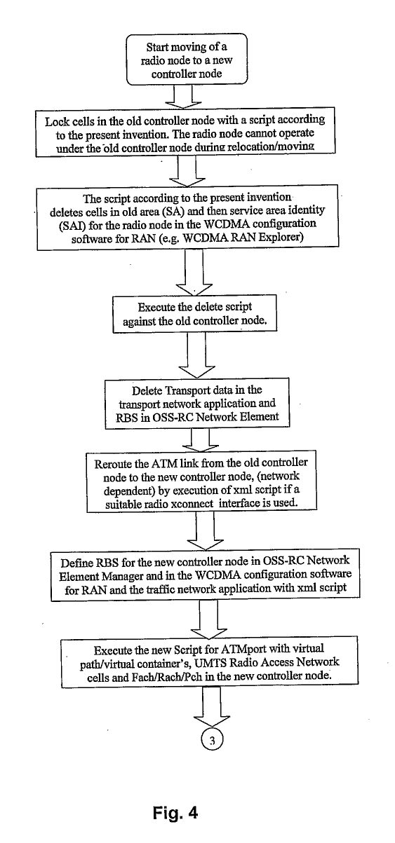

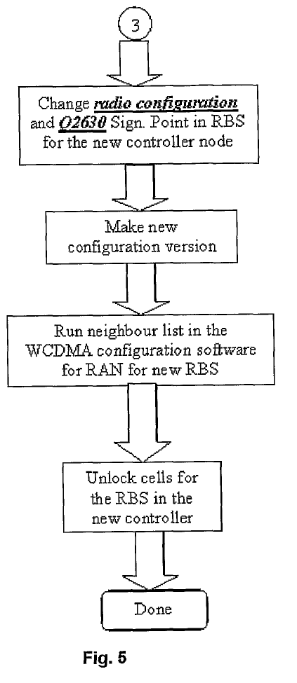

The features according to the present invention are achieved with the use of a new algorithm, where this algorithm among others includes creation of a new macro, cf. FIG. 3, FIG. 4 and FIG. 5. Where FIG. 3 depicts a particular solution from the real world, whereas the two latter figures discloses a solution of more general character.

A new macro according to the present invention can be adapted to handle xml scripts so that the only action to be executed by a telecom installer is to enter necessary input data into the macro and then import the xml files into planned area in Configuration Software and activate a planned area. The planned area is a working area suitable for development of software and/or for entering data into applications. The planned area is a mirror image of a real time area comprising real time applications. The principle is that you can work, enter data or developed software without interrupting vital real time traffic, furthermore you will be able to verify and test your work without interruptions of real time traffic or other network traffic. After testing or when the work with the planned area is finished one may copy the planned area into the “real area” that is the operating area. In this manner one can implement changes without unnecessary interruptions to the network traffic. The planned area is localised in the WCDMA Ran Explorer, however these types of mirror image working areas are of generic nature and they are widely used by for instance telecom vendors.

By using the Configuration Software together with a macro, the result is a more automatic process.

In the example above the features of the present invention were achieved using a macro adapted for xml scripts, however the basic concept of reusing data, and further creating a macro tailored for relocation of nodes can be achieved with the use of macros adapted to other script languages. In fact the choice of xml scripts is an example and macros can be created so as to comply with other script languages. Further the wording “planned area” is meant as an example for this kind of working area and any kind of working area suited for import and export of script files can be used. FIG. 3 makes reference to an exemplified embodiment of the present invention, where the script language used was xml, and the radio node to be moved was a RBS node, further the controller nodes were RNC nodes.

Hence this exemplification, taken from the “real world” discloses a method of handling equipment from Ericsson AB, a more general algorithm is described in the following section.

### GENERAL MODE FOR CARRYING OUT THE INVENTION

The present invention will no be described by reference to the accompanying drawings FIGS. 4 and 5.

After the decision to move a radio base station from one controller node to another controller node has been taken, the telecom operator must launch appropriate applications which include scripts for automatic or semiautomatic moving the radio base station. Such an application will normally be a tool for network planning and control such as OSS-RC and/or configuration software for UMTS RAN such as WCDMA RAN Explorer. The script(s) according to the present invention will be used for locking cells in the old controller node, as long as the radio base station cannot operate under the old controller node during relocation/moving.

Having locked the cells in the old area, then the next step performed by the script(s) is to delete at least one cell in the old area (SA) and thereafter delete the service area identity for the radio base station in the configuration software for the network, such as 2.5G, 3G or 4G networks.

Having locked cells and deleted cells and their corresponding identities the next step is to execute a delete script or the delete routine in the macro according to the present invention, this delete routine/script deletes the old controller node. Delete, is not meant in the sense of deleting a controller node physically, nor is it to delete all radio base stations associated with this controller node, it refers to the radio base station that is to be moved, hence references to this radio base station are deleted in the old controller node.

The next step performed by the operator/script is to delete transport data in the transport network application and similarly or substantially similarly to delete the radio base station in the network element tool for network planning and control, e.g. ONE.

Having finished the previous step, then the next step is to reroute the link from the old controller node by execution of the script according to the present invention. This rerouting is network dependent and consequently a radio xconnect adapted to support these scripts must be used. The link can typically be an ATM link.

The steps indicated above concerns deletion of the radio base station from the “old” controller node, the next step is to define the radio base station at the new controller node in the network element tool for network planning and control, and in the configuration software for the network, and in the traffic network application using the scripts according to the present invention.

After having defined the radio base station in the previous step, in this step one will execute the new Script for ATMport with virtual path/virtual containers, UMTS Radio Access Network cells and Fach/Rach/Pch in the new controller node.

In this step is the radio configuration changed according to the new controller node, the cells etc. and Q2630 Sign. Point in RBS for the new controller node.

A new configuration version is created, using the script according to the present invention, this includes storing data internally in the radio base station/node.

The neighbour list is executed in configuration software for the network for the new controller node.

Finally are the cells for the radio base station unlocked in the new controller node, and the radio base station can operate as normal.

The steps indicated in this section are preferably executed by a script according to the present invention, and more preferably by an xml script.
AESA ATM end addresses, i.e. end point address, e.g. RNC and RBS have their own unique AESA.
ATM Asynchronous Transfer Mode
Atmport Asynchronous Transfer Modus port, Termination Point (PDH, SDH for GSM) or simply Termination point, transmission termination point.
BTS Base Transceiver Station
Cello Is an Ericsson platform product from which it is possible to develop a switching network node such as a small to medium sized Asynchronous Transfer Mode (ATM) switch.

Today the design of Cello emphasizes WCDMA products, such as the Radio Network Controller.
CV Configuration Version
DNS Domain Name Server
EMAS Element Manager Application System i.e. a thin client
ETM-4 Extension Terminal Module, type 4, i.e. a transmission board/card
Fach Forward Access Channel (FACH) A point-to-multipoint downlink transport channel used to convey data to one or more UEs.
GSM Global System for Mobile communication
MIM Management Identity Model, i.e. the software version
MOScript Script based on Cello platform
Nbap Node B Application Protocol
NBAPC Node B Application Protocol C
NBAPD Node B Application Protocol D
NE/RBS NE, network element hence in this case Network Element.
Node B Node-B is a term used in UMTS to denote the BTS (base transceiver station). In contrast with GSM base stations, Node-B uses WCDMA as air transport technology. As in all cellular systems, such as UMTS and GSM, Node-B contains radio frequency transmitter(s) and the receiver(s) used to communicate directly with the mobiles, which move freely around it. In this type of cellular networks the mobiles cannot communicate directly with each other but have to communicate with the BTSs. [http://en.wikipedia.org/wiki/Node_B]
ONE OSS-RC Network Element Manager OSS-RC Operation System Support Radio Configuration, tool for network planning and control on a hierarchical top level.
Pch Paging Channel Downlink point-to-multipoint Transport Channel, used to page a group of UEs in the Coverage Area of the cell.
Q2630 Sign Q.2630 Signalling standard in UMTS for Circuit Swiched setup of call or streaming (video, videocall). Belongs to ATM Layer AAL2. Q.2630 Signalling point includes AESA (ATM End Address)
Rach Random AccessChannel (RACH)

Uplink Transport Channel used by the UE to initiate access to the WCDMA RAN access point. It can also be used to carry small data packets.
RAN Radio Access Network
Ranos Radio Access Network Operating System, a network operating system with functionalities being more or less similar to WCDMA RAN Explorer.
RBS Radio Base Station
RbsGroup Radio Base Station Group
RC Radio Configuration when used in connection with OSS-RC, when used together with AAL2RC it is an abbreviation for routing case e.g. Delete Old RNC RC(Routing Case)
RNC Radio Network Control
   RNC Module Radio Network Controller Module
RXI Radio Xconnect Interface
SA Service Area.
SAI Service Area Identity
TN Transport Network
TN application Transport Network Application, to keep track on ports, links etc
TPC Wizard Transport Configuration Wizard input window for definition of transport data, ATMPort,
VPI/VCI and AESA.
UE User Equipment
UMTS Universal Mobile Telecommunications System
Utran UMTS Radio Access Network
VC Virtual Container
VP Virtual Path
VPI/VCI Virtual Path Identity/Virtual Container Identity
WCDMA Wideband Code Division Multiple Access
WCDMA RAN Explorer Handling the radio network with respect to the radio part
Xconnect Cross connect
Aal2 Signalling level within ATM.
Aal2 PathId Name (label) which defines the VCI line for the Aal2 line In this case represented with RBS identity to describe the VCI for the RBS.
Aal2Routingcase Routing case for RBS line to describe which RNC the RBS should route towards (input is for ins. AESA for RNC). Routing case is used in all type of routing tables dependent of which system you are routing in (ATM, IP, etc.)

### REFERENCES

WIKIPEDIA. Node-B. http.//enwikipedia.org/wiki/Node_B.
ERICSSON RADIO SYSTEMS AB. Cello Overview, document no.: EN/LZT 123 5321 Rev. R2A. Ericsson Radio Systems AB. p. 5.

1-16. (canceled)

17. A system for moving a node within a real time communications network, where said node initially is at least coupled to a first controller node and said node is de-coupled and moved from the first controller node to a second controller node, the system comprising:
a macro adapted to handle moving of the node wherein the macro further comprises:
a means for deletion of data in the first controller node;
a means for generation of new data adapted to the second controller node by reusing data associated with said node; and
a means configured to assign an identity to said node associated with the second controller node.

18. The system according to claim 17 wherein the means adapted to delete data in the first controller node are further configured to delete: cells in an area associated with the first controller node, service area identity for the node, transport data in a transport network application and the node in a network element tool for network planning and control.

19. The system according to claim 17 wherein the means for deletion of data in the first controller node is further configured to lock cells in the first controller node.

20. The system according to claim 19, wherein the means adapted to delete data in the first controller node are further configured to delete: cells in an area associated with the first controller node, service area identity for the node, transport data in a transport network application and the node in a network element tool for network planning and control.

21. The system according to claim 20, wherein the means is further configured to reroute a connection link from the first controller node to the second controller node.

22. The system according to claim 20, wherein the means configured to assign an identity to said node associated with the second controller node is further adapted to define the node at the second controller node.

23. The system according to claim 22, wherein the means configured to assign an identity to said node associated with the second controller node is further configured to create a new configuration version on the node by storing system data internally in the node.

24. The system according to claim 23, wherein the means configured to assign a identity to said node associated with the second controller node is further configured to unlock cells for the node in the second controller node.

25. The system according to claim 17, wherein the means configured to assign a identity to said node associated with the second controller node is further configured to unlock cells for the node in the second controller node.

26. The system according to claim 17, wherein the node is a radio base station, and the first and the second controller nodes are radio network controller nodes.

27. The system according to claim 17, wherein the network is one selected from the group consisting of a 2.5 G, 3G and 4G network.

28. A method for moving a node within a real time communications network, wherein said node initially is at least coupled to a first controller node and said node is de-coupled and moved from the first controller node to a second controller node, comprising the steps of:
utilizing a macro that executes at least the following further steps:
deleting data in the first controller node;
generating new data adapted to the second controller node by reusing data associated with said node; and
assigning an identity associated with the second controller node to said node.

29. The method according to claim 28, wherein the step of deleting data in the first controller node further comprises the step of locking cells in the first controller node.

30. The method according to claim 29, wherein the step of deleting data in the first controller node comprises the further step of deleting cells in an area associated with the first controller node, deleting service area identity for the node, and deleting transport data in a transport network application and the node in a network element tool for network planning and control.

31. The method according to claim 30, wherein the macro further reroutes a connection link from the first controller node to the second controller node.

32. The method according to claim 28, wherein step of assigning an identity associated with the second controller node includes the further step of defining the node at the second controller node.

33. The method according to claim 32, wherein the macro creates a new configuration version on the node by storing system data internally in the node.

34. The method according to claim 33, wherein the step of assigning a identity associated with the second controller node to said node further includes the step of unlocking cells for the node in the second controller node.

35. The method according to claim 28, wherein the step of assigning a identity associated with the second controller node to said node further includes the step of unlocking cells for the node in the second controller node.
